(19) United States
(12) Patent Application Publication
(10) Pub. No.: US 2008/0084084 A1
(43) Pub. Date: Apr. 10, 2008

(54) Supporting strut for a wheelchair

(75) Inventor: Chang-Ting Hsieh, Taoyuan Hsien (TW)

Correspondence Address: BACON & THOMAS, PLLC, 625 SLATERS LANE, FOURTH FLOOR, ALEXANDRIA, VA, 22314, US

(73) Assignee: Q. S. CONTROL CORP., Taoyuan Hsien (TW)

(21) Appl. No.: 11/519,895

(22) Filed: Sep. 13, 2006

(51) Int. Cl. B60N 2/02

(52) U.S. Cl. 296/65.04

(57) ABSTRACT

A supporting strut for a wheelchair has a longitudinal shaft and a cross-shaft. The cross-shaft extends perpendicularly from the longitudinal shaft and has a mounting bracket, two proximal brackets, two distal brackets, a medial pivot hole and a brace pivot hole. The mounting bracket is U-shaped, is formed on and extends longitudinally from the distal end of the cross-shaft. The proximal brackets are mounted opposite to each other on the cross-shaft near the proximal end and are connected to the longitudinal shaft. The distal brackets are mounted opposite to each other on the cross-shaft near the distal end and are connected to the mounting bracket. The medial pivot hole is formed through the cross-shaft between the proximal and distal ends parallel to the longitudinal shaft. The brace pivot hole is formed through the cross-shaft between the medial pivot hole and the proximal end parallel to the longitudinal shaft.

### BACKGROUND OF THE INVENTION

1. Field of the Invention

The present invention relates to a supporting strut, and more particularly to a supporting strut used to support a wheelchair between two wheels.

2. Description of Related Art

With reference to FIG. 5, a conventional wheelchair has a seat (45), a mounting frame (30), two primary wheels (40) and two secondary wheels (41).

The seat (45) has a bottom and two side edges.

The mounting frame (30) is attached to and extends down from the bottom of the seat (45) and has two side frames (31), two supporting struts (32) and two braces (33).

The side frames (31) are connected respectively to and extend down respectively from the edges of the seat (45) parallel to each other.

The supporting struts (32) are metal and T-shaped, are connected pivotally to each other in an X-configuration and connected respectively to the side frames (31).

Each supporting strut (32) has a longitudinal shaft (320) and a cross-shaft (321). The longitudinal shafts (320) are connected respectively to the side frames (31) below the seat (45). The cross-shafts (321) are connected respectively to and extend perpendicularly respectively from the longitudinal shafts (320), and each cross-shaft (321) has a proximal end, a distal end and a mounting bracket (322). The proximal end of the cross-shaft (321) is connected to the longitudinal shaft (320). The mounting bracket (322) is U-shaped, is attached to and protrudes longitudinally from the distal end of the cross-shaft (321) and is connected pivotally to the side frame (31) opposite to the longitudinal shaft (320).

The braces (33) are connected respectively to the side frames (31) and the supporting struts (32), and each brace (33) has an outer end and an inner end. The outer ends of the braces (33) are rotatably mounted respectively around the side frames (31) near the longitudinal shafts (320). The inner ends of the braces (33) are connected respectively to the cross-shafts (321).

The primary wheels (40) are rotatably connected respectively to the side frames (31).

The secondary wheels (41) are connected respectively to the side frames (31) in the front of the primary wheels (40).

However, the conventional supporting strut (32) for a wheelchair has the following shortcomings.

1. The support strut (32) is metal so the proximal and distal ends of the cross-shaft (321) need to be concave to conform respectively to the longitudinal shaft (320) and the mounting bracket (322). In addition, the longitudinal shaft (320), the cross-shaft (321) and the mounting bracket (322) are welded so the supporting strut (32) must be polished and painted after welding to keep the supporting strut (32) from rusting. This will increase the cost and time for manufacturing the supporting strut (32).

2. Furthermore, paint on the supporting strut (32) may chip off when the supporting struts (32) knock against each other, which will result in the supporting struts (32) rusting.

3. Manually welding the longitudinal shaft (320), the cross-shaft (321) and the mounting bracket (322) may result in weak joints in the supporting strut (32).

4. Since the supporting strut (32) is metal, the wheelchair is heavy and inconvenient to use.

The supporting strut for a wheelchair in accordance with the present invention mitigates or obviates the aforementioned problems.

### SUMMARY OF THE INVENTION

The main objective of the present invention is to provide a supporting strut for a wheelchair, which is strong and lightweight and can be manufactured quickly and easily.

The supporting strut for a wheelchair has a longitudinal shaft and a cross-shaft. The cross-shaft is formed on and extends perpendicularly from the longitudinal shaft and has a mounting bracket, two proximal brackets, two distal brackets, a medial pivot hole and a brace pivot hole. The mounting bracket is U-shaped, is formed on and extends longitudinally from the distal end of the cross-shaft. The proximal brackets are mounted opposite to each other on the cross-shaft near the proximal end and are connected to the longitudinal shaft. The distal brackets are mounted opposite to each other on the cross-shaft near the distal end and are connected to the mounting bracket. The medial pivot hole is formed through the cross-shaft between the proximal and distal ends parallel to the longitudinal shaft. The brace pivot hole is formed through the cross-shaft between the medial pivot hole and the proximal end parallel to the longitudinal shaft.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of two supporting struts in accordance with the present invention on a wheelchair;

FIG. 2 is a perspective view of the supporting strut in FIG. 1;

FIG. 3 is a cross sectional top view of the supporting strut in FIG. 2;

FIG. 4 is a cross section top view of another embodiment of a supporting strut in accordance with the present invention; and

FIG. 5 is a perspective view of a conventional supporting strut in accordance with the prior art on a wheelchair.

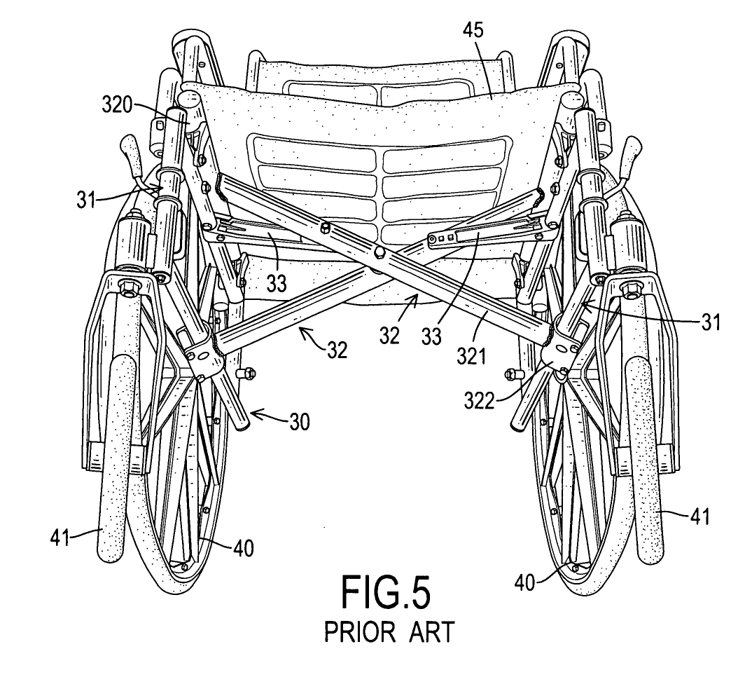

### DETAILED DESCRIPTION OF THE PREFERRED EMBODIMENT

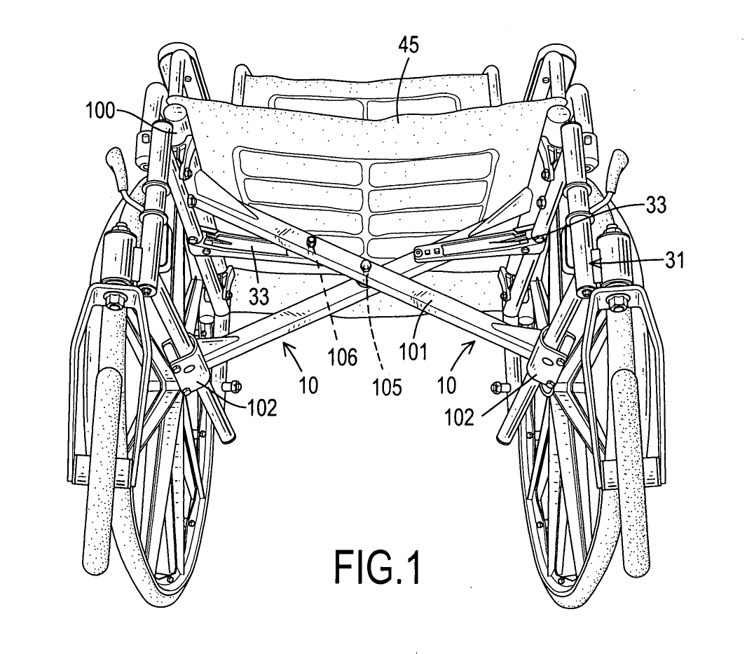

With reference to FIG. 1, two supporting struts (10) in accordance with the present invention for a wheelchair having a seat (45), two side frames (31), two braces (33), two primary wheels (40) and two secondary wheels (41) are connected to the side frames (31), and each supporting strut (10) is T-shaped and has a longitudinal shaft (100) and a cross-shaft (101).

The seat (45) has a bottom and two edges. The side frames (31) are connected respectively to and extend down respectively from the edges of the seat (45) parallel to each other. The braces (33) are connected respectively to the side frames (31), and each brace (33) has an outer end and an inner rear end. The outer ends are rotatably mounted respectively around the side frames (31).

The primary wheels (40) are rotatably connected respectively to the side frames (31). The secondary wheels (41) are connected respectively to the side frames (31) in the front of the primary wheels (40).

The longitudinal shafts (100) are hollow, are connected parallel respectively to the side frames (31) below the seat (45) and have a cross-section. The cross-section may be circular.

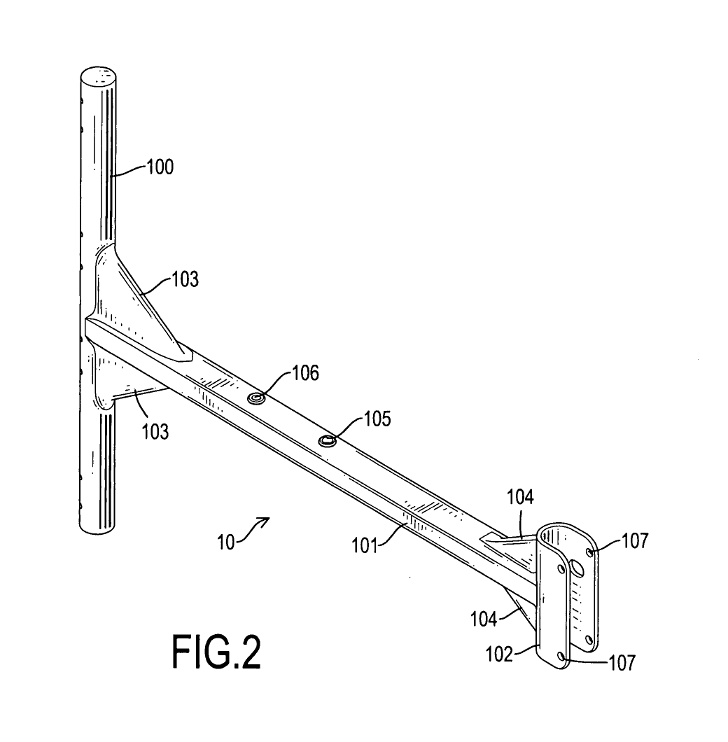

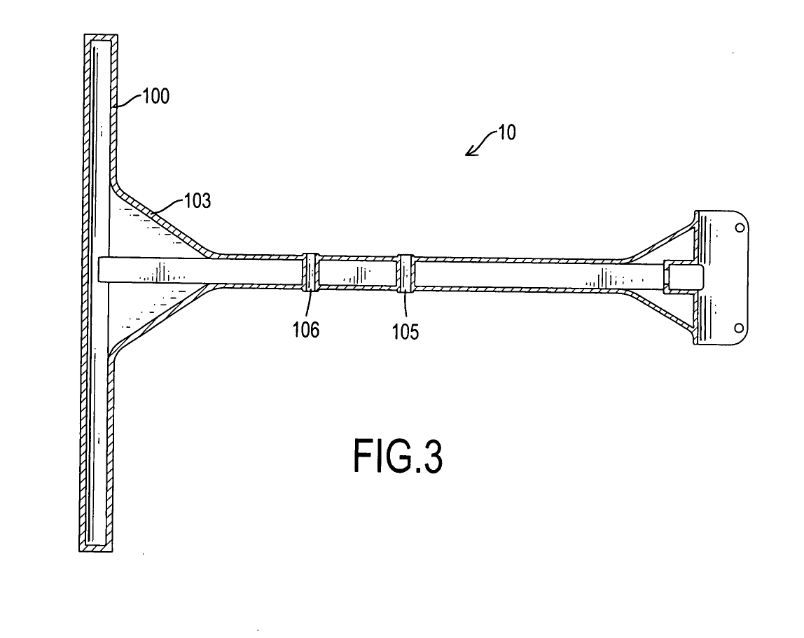

The cross-shafts (101) are hollow, are formed respectively with and extend perpendicularly respectively from the longitudinal shafts (100) and are pivotally connected respectively to the side frames (31) opposite to the longitudinal shafts (100). With further reference to FIGS. 2, 3 and 4, each cross-shaft has a proximal end, a distal end, a front, a rear, a middle, a cross-section, a mounting bracket (102), two proximal brackets (103), two distal brackets (104), a medial pivot hole (105), a brace pivot hole (106) and two pivot tubes. The cross-section of the cross-shaft (101) may be rectangular.

The mounting bracket (102) is U-shaped, is formed on and protrudes longitudinally from the distal end of the cross-shaft (101), is mounted around the side frame (31) and has two distal edges and multiple mounting holes (107). The mounting holes (107) are formed transversely through the mounting bracket (102) near the distal edges.

The proximal brackets (103) may be triangular and hollow, are mounted opposite to each other on the front and the rear of the cross-shaft (101) near the proximal end and are connected to the longitudinal shaft (100).

The distal brackets (104) may be triangular and hollow, are mounted opposite to each other on the front and the rear of the cross-shaft (101) near the distal end and are connected to the mounting bracket (102).

The medial pivot hole (105) is formed through the cross-shaft (101) from the front to the rear and aligns with the medial pivot hole (105) through the other cross-shaft (101).

The brace pivot hole (106) is formed from the front to the rear through the cross-shaft (101) between the medial pivot hole (105) and the proximal end of the cross-shaft (101), is connected pivotally to the inner end of the brace (33).

The pivot tubes are formed in the cross-shaft (101) between the front and the rear and are held respectively inside the medial pivot hole (105) and the brace pivot hole (106).

The supporting strut (10) is manufactured by a mold assembly with an upper mold and a lower mold. Each mold has a cave. In the manufacturing process, melted plastic material is led into the caves of the upper mold and lower mold, then a compressed inert gas (such as a nitrogen gas) is injected into the molds to blow the plastic material to form the hollow supporting strut (10) based on the shapes of the caves. Two posts are arranged in the molds to form the pivot tubes, the medial pivot hole (105) and the brace pivot hole (106).

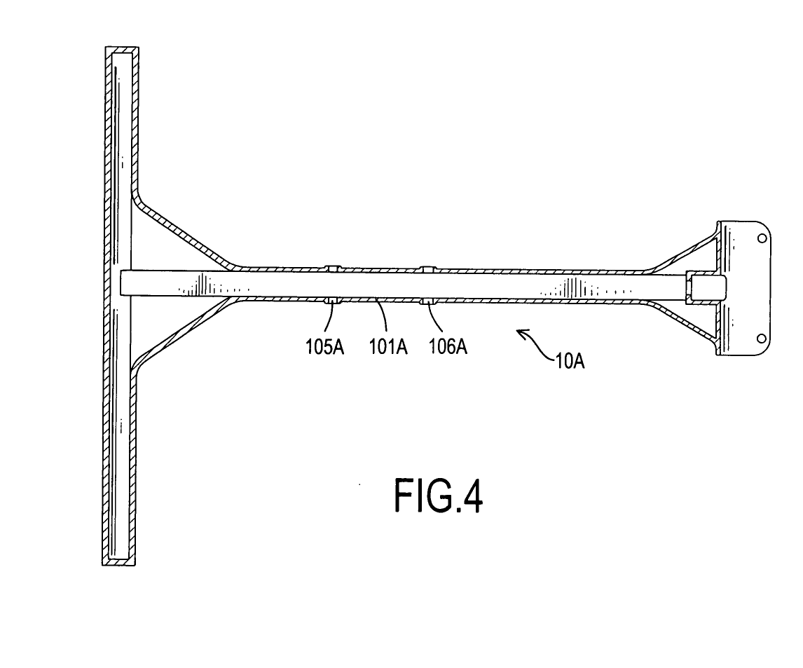

With reference to FIG. 4, the medial pivot hole (105) and the brace pivot hole (106) can be formed by directly drilling the cross-shaft (101) without using the posts.

The supporting strut (10) as described has the following advantages.

1. The supporting strut (10) is plastic and is formed by molding. The supporting strut (10) can be mounted directly on the wheelchair without further processing, which will decrease the cost and time for manufacturing a supporting strut (10).

2. Since the supporting strut (10) is made of plastic, the supporting strut (10) is lighter than a conventional supporting strut (32) made of metal. Furthermore, the plastic supporting strut (10) will not rust so users will not need to paint the supporting strut (32).

3. The longitudinal shaft (100), the cross-shaft (101) and the mounting bracket (102) are molded as a single piece so no weakness will exist between pieces as a result of welding or otherwise connecting individual parts.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A supporting strut for a wheelchair and the supporting strut being made of plastic, being T-shaped and comprising
a longitudinal shaft being hollow and having a cross section; and
a cross-shaft being hollow, being formed with and extending perpendicularly from the longitudinal shaft and having a proximal end;
a distal end;
a front;
a rear;
a middle;
a cross section;
a mounting bracket being U-shaped, being formed on and protruding longitudinally from the distal end of the cross-shaft and having two distal edges;
two proximal brackets being mounted opposite to each other on the front and the rear of the cross-shaft near the proximal end and being connected to the longitudinal shaft;
two distal brackets being mounted opposite to each other on the front and the rear of the cross-shaft near the distal end and being connected to the mounting bracket;
a medial pivot hole being formed through the cross-shaft from the front to the rear; and
a brace pivot hole being formed from the front to the rear through the cross-shaft between the medial pivot hole and the proximal end of the cross-shaft.

2. The supporting strut as claimed in claim 1, wherein
the proximal brackets are triangular and hollow; and
the distal brackets are triangular and hollow.

3. The supporting strut as claimed in claim 1, wherein
the cross-section of the longitudinal shaft is circular; and
the cross-section of the cross-shaft is rectangular.

4. The supporting strut as claimed in claim 1, wherein the cross-shaft further has two pivot tubes formed in the cross-shaft between the front and the rear and are held respectively in the medial pivot hole and the brace pivot hole.

5. The supporting strut as claimed in claim 1, wherein the mounting bracket further has multiple mounting holes formed transversely through the mounting bracket near the distal edges.

6. The supporting strut as claimed in claim 2, wherein
the cross-section of the longitudinal shaft is circular; and
the cross-section of the cross-shaft is rectangular.

7. The supporting strut as claimed in claim 6, wherein the cross-shaft further has two pivot tubes formed in the cross-shaft between the front and the rear and are held respectively in the medial pivot hole and the brace pivot hole.

8. The supporting strut as claimed in claim 7, wherein the mounting bracket further has multiple mounting holes formed transversely through the mounting bracket near the distal edges.
